(19) United States
(12) Patent Application Publication
(10) Pub. No.: US 2013/0104343 A1
(43) Pub. Date: May 2, 2013

(54) TORSION SPRING AND FOLDING DEVICE

(71) Applicants: NA WANG, Shenzhen City (CN); YUN WANG, Shenzhen City (CN); YUAN-MING WANG, Shenzhen City (CN); JIAN-YONG YANG, Shenzhen City (CN)

(72) Inventors: NA WANG, Shenzhen City (CN); YUN WANG, Shenzhen City (CN); YUAN-MING WANG, Shenzhen City (CN); JIAN-YONG YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/526,584

(22) Filed: Jun. 19, 2012

(30) Foreign Application Priority Data
Oct. 28, 2011 (CN) 201110333549.9

(51) Int. Cl. E05F 1/12; F16F 1/06

(52) U.S. Cl. 16/304; 267/155

(57) ABSTRACT

A folding device includes a main body, a cover, and a torsion spring. The cover is rotatably connected to the main body and capable of covering the main body, the cover comprising a supporting member. The torsion spring renders the cover spring-loaded, to rotate the cover open from the main body. The torsion spring includes a coil, a first arm and a second arm. The first arm includes a first portion extending from one end of the coil along a first direction that is perpendicular to an axis of the coil; and a second portion extending from the end of the first portion along a second direction different from the first direction. The first portion and the second portion support the supporting member from different positions and different lengths when the cover is opened. The second arm restricts against the main body.

### BACKGROUND

1. Technical Field

The present disclosure relates to torsion springs, and particularly to a folding device using a torsion spring.

2. Description of Related Art

A torsion spring used in a folding device, such as a notebook computer, a portable DVD player, provides a force to open the cover, and supports the cover when the cover is opened. The torsion spring may include a coil, and two beeline arms extending from opposite ends of the coil. In operation, when the cover is open, the end of one arm supports the cover and prevents it from closing, but the same arm, when not under tension, may easily move with respect to the cover to cause the cover to wobble.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of a folding device, the folding device has a torsion spring.

FIG. 2 is an enlarged view of a circled portion II of FIG. 1.

FIG. 3 is an inverted view of FIG. 2.

FIG. 4 is an isometric view of the torsion spring in FIG. 1.

### DETAILED DESCRIPTION

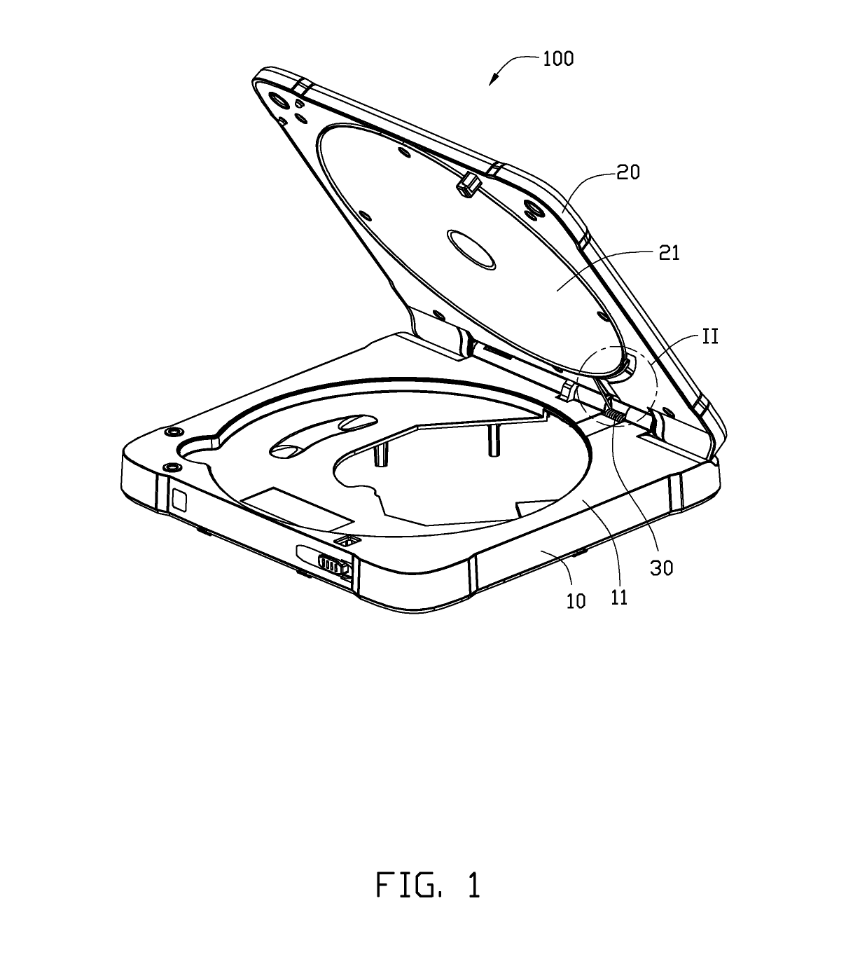

Referring to FIG. 1, a folding device 100 includes a main body 10, a cover 20 rotatably connected to the main body 10, a torsion spring 30 connected between the main body 10 and the cover 20. The cover 20 is capable of being folded down to the main body 10. The torsion spring 30 provides an elastic force urging the cover 20 to open.

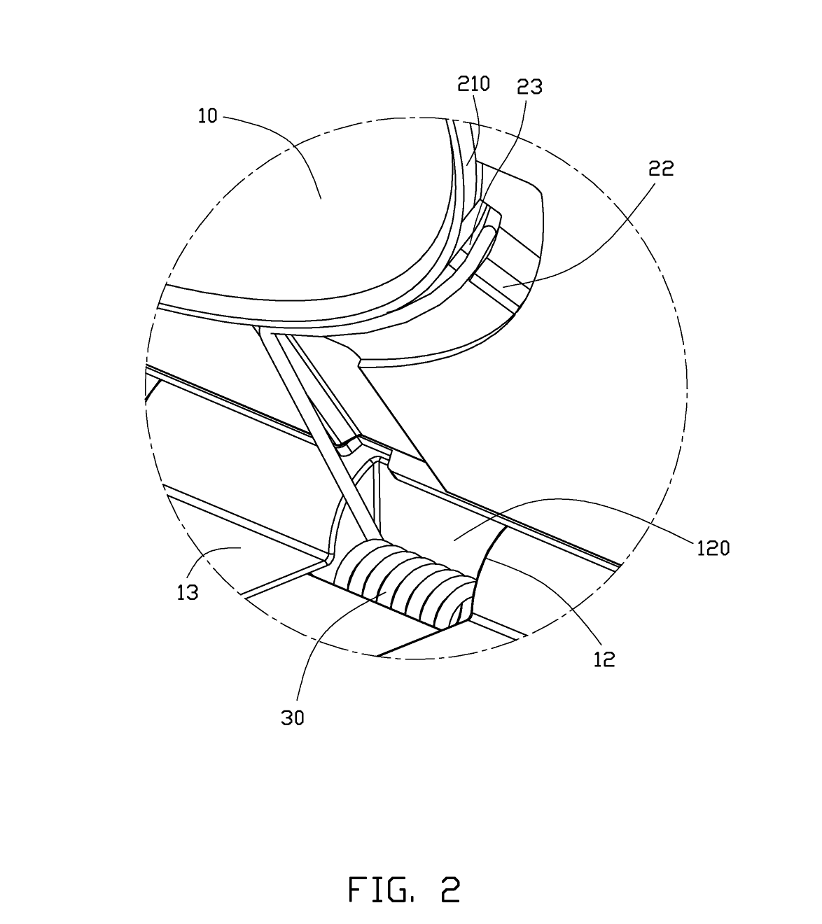

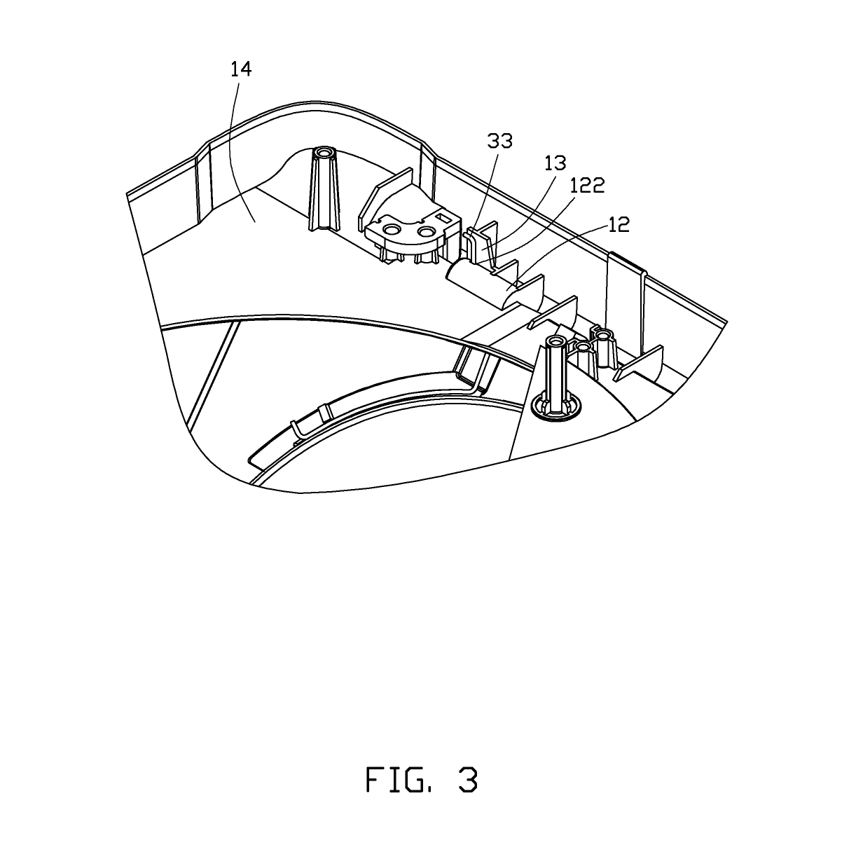

Referring to FIGS. 2 and 3, one side of the cover 20 is rotatably connected to one side of the main body 10. The cover 20 defines a fixing hole 23, and a supporting member 21 projecting therefrom, and a restricting member 22. The supporting member 21 and the restricting member 22 protrude from the inner surface of the cover 20 facing the main body 10. The supporting member 21 is adjacent to the restricting member 22. The supporting member 21 is a circular disk having a cambered surface 210 perpendicularly protruding from the cover 20. In another embodiment, the supporting member 21 can also be a semicirclular disk, a ring, a semicirclular ring adjacent to the restricting member 22. The restricting member 22 is a tab protruding from the cover 20. The fixing hole 23 is defined between the supporting member 21 and the restricting member 22. The fixing hole 23 is a through hole which runs from cambered surface 210 to one side of the restricting member 22.

The main body 10 includes a first surface 11 facing the cover 20, a second surface 14 away from the cover 20, a receiving part 12 positioned on the first surface 11, and a blocking member 13 protruding from the second surface 14. The receiving part 12 defines a receiving groove 120 which is concave from the first surface 11. The bottom of the receiving part 12 defines a through hole 122. The blocking member 13 is a plate adjacent to the receiving part 12.

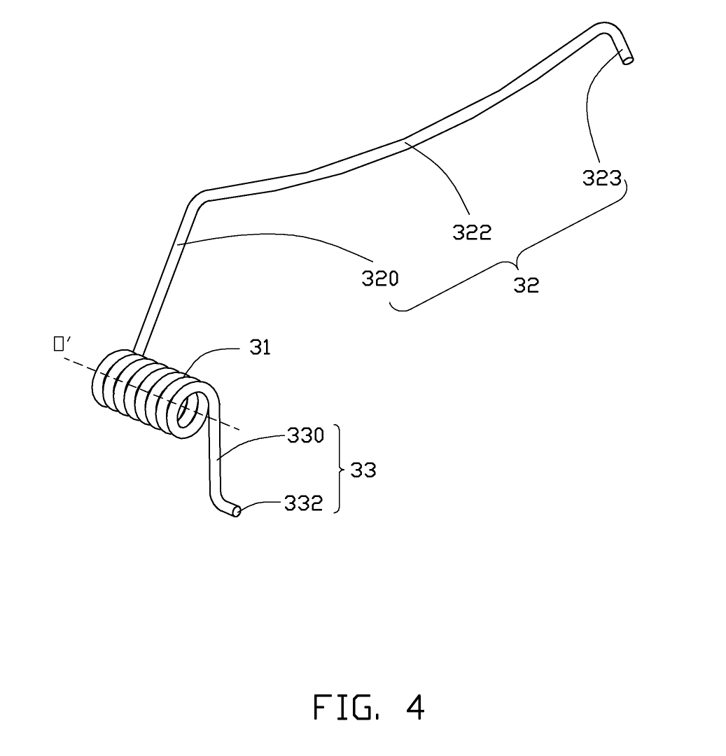

Referring to FIG. 4, the torsion spring 30 includes a coil 31, a first arm 32, and a second arm 33. The first arm 32 and the second arm 33 extend from opposite ends of the coil 31. The first arm 32 includes a first portion 320, a second portion 322, and a third portion 323. An obtuse angle is formed between the first portion 320 and the second portion 322. The first portion 320 and the third portion 323 are on the same side of the second portion 322 when seen from a first aspect. Otherwise, the first portion 320 and the third portion 323 are on different side of the second portion 322 from a second aspect different from the first aspect.

The first portion 320 extends from one end of the coil 31 along a direction perpendicular to the axis O′ of the coil 31. The second portion 322 extends from one end of the first portion 320 away from the coil 31, and the second portion 322 deviates from the first portion 320. The third portion 323 is bent perpendicularly and extends from one end of the second portion 322 away from the first portion 320, thus the end of the second portion 322 and the third portion 323 form a hook.

The second arm 33 includes a fourth portion 330 and a fifth portion 332 connected end-to-end. The fourth portion 330 extends from the other end of the coil 31 along a direction perpendicular to the axis O′ of the coil 31. The fifth portion 332 perpendicularly bends and extends from the end of the fourth portion 330. The fifth portion 332 is parallel to the axis O′ of the coil 31.

Hereinafter, the assembly of the torsion spring 30 is described in detail. First, the second arm 33 is inserted through the through hole 122, thus the second arm 33 extends from the first surface 11 to the second surface 14, and the coil 31 is received in the receiving groove 120. The first arm 32 extends toward the cover 20, and at this time, the fifth portion 332 is restricted by the blocking member 13 (see FIG. 3); second, the second portion 322 is placed between the supporting member 21 and the restricting member 22, and the third portion 323 is inserted into the fixing hole 23, the second portion 322 binds against the cambered surface 210, at this time, the fixing hole 23 is sealed by the third portion 323, and the second portion 322 is restricted between the supporting member 21 and the restricting member 22. At this time, the assembly of the torsion spring 30 is finished. It is understood that, the size of the fixing hole 23 is defined according to the appearance of the third portion 323.

In operation, the cover 20 is folded down to be fastened to the main body 10, and the first arm 32 and the second arm 33 are thereby twisted to store an elastic force. When the cover 20 is unfastened from the main body 10, the cover 20 is opened because of the elastic force, and the second portion 322 supports the cambered surface of the supporting portion 21. When the cover 20 is opened the first portion 320 and the second portion 322 provide support at different positions and from different directions, thus the risk of the first arm 32 moving relative to the cover 20 reduces. Moreover, the third portion 323 is inserted into the fixing hole 23, and the second portion 322 is restricted between the supporting member 21 and the restricting member 22, therefore, the risk of the first arm 33 moving with relative to the first arm 33 is low, and the first arm 33 is restricted to holding the cover 20 in a very stable manner.

It is to be understood, however, that even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A folding device, comprising:
a main body;
a cover rotatably connected to the main body and capable of covering on the main body; and
a torsion spring providing a force to allow the cover to rotate with the main body to open, the torsion spring comprising:
a coil;
a first arm extending from one end of the coil; and
a second arm extending from the other end of the coil opposite to the first arm;
wherein the first arm comprises a first portion, a second portion, and a third portion; the second portion connects the first portion and the third portion; and the first, second, and third portion combines to restrict the cover to move in at least three directions, the second arm restricts against the main body.

2. The folding device of claim 1, wherein the second portion connects one end of the first portion away from the coil, and an obtuse angle is formed between the first and second portions.

3. The folding device of claim 1, wherein the first portion and the third portion are on the same side of the second portion when seen from a first aspect, and the first portion and the third portion are on different sides of the second portion when seen from a second aspect different from the first aspect.

4. The folding device of claim 1, wherein the cover comprises a supporting member, the first portion and the second portion support the supporting member.

5. The folding device of claim 4, wherein the cover further defines a fixing hole besides the supporting member, the third portion bends from the second portion, the third portion is inserted into the fixing hole, and the third portion supports the cover when the cover is opened.

6. The folding device of claim 5, wherein the fixing hole is sealed by the third portion.

7. The folding device of claim 4, wherein the cover further comprises a restricting member, the restricting member is adjacent to the supporting member, the second portion is restricted between the supporting member and the restricting member.

8. The folding device of claim 1, wherein the main body comprises a receiving part for receiving the coil, and a through hole defined in the receiving part for allowing the second arm to pass through the receiving part.

9. The folding device of claim 1, wherein the second portion is arc shaped.

10. A folding device, comprising:
a main body;
a cover rotatably connected to the main body and capable of covering on the main body; and
a torsion spring providing a force to allow the cover to rotate with respect to the main body to open, and supporting the cover when the cover is opened; the torsion spring comprising:
a coil;
a first arm with a second portion being arc shaped supporting the cover when the cover is opened; and
a second arm restricting against the main body.

11. The folding device of claim 10, wherein the first arm further comprises a first portion, the first portion extends from one end of the coil along a first direction perpendicular to an axis of the coil, the second potion extends from the end of the first portion away from the coil, and an obtuse angle is formed between the first and second portions.

12. The folding device of claim 11, wherein the first arm further comprises a third portion, the third portion extends from the end of the second portion along a second direction from the first direction, the cover further defines a fixing hole, the third portion bends toward a second direction different from the first direction to insert into the fixing hole.

13. The folding device of claim 12, wherein the first portion and the third portion are one the same side of the second portion when seen from a first aspect, and the first portion and the third portion are one the different sides of the second portion when seen from a second aspect different from the first aspect.

14. The folding device of claim 12, wherein the cover comprises a supporting member with a cambered surface which matches the second portion, the second portion supports the cambered surface, when the cover is opened.

15. The folding device of claim 14, wherein the cover further comprises a restricting member, the restricting member is adjacent to the supporting member, the second portion is restricted between the supporting member and the restricting member.

16. A torsion spring comprising:
a coil, the coil having a first end and a second end opposite to the first end;
a first arm extending from the first end of the coil;
a second arm extending from the second end of the coil;
wherein, the first arm comprises:
a first portion extending from the first end of the coil along a first direction perpendicular to an axis of the coil;
a second portion extending from the end of the first portion away from the coil; and bended into an arc, and
a third portion extending from the end of the second portion away from the first portion and bending toward a second direction different from the first direction.

17. The torsion spring of claim 16, wherein an obtuse angle is formed between the first and second portions.

18. The torsion spring of claim 16, wherein the first portion and the third portion are on the same side of the second portion when seen from a first aspect, and the first portion and the third portion are on different sides of the second portion from a second aspect different from the first aspect.

19. The torsion spring of claim 16, wherein the second portion and the third portion form a hook.

20. The torsion spring of claim 16, wherein the second arm comprises a fourth portion and a fifth portion, the fourth portion extends from the second end of the coil along a third direction different from the first direction and the second position, the fifth portion perpendicularly bends from the end of the fourth portion away from the coil.
